(19) United States
(12) Patent Application Publication
(10) Pub. No.: US 2017/0336857 A1
(43) Pub. Date: Nov. 23, 2017

(54) METHOD AND DEVICE FOR CONTROLLING OPERATIONAL STATE OF DATA CENTER

(71) Applicant: Beijing Baidu Netcom Science And Technology Co., Ltd., Beijing (CN)

(72) Inventors: Xiaogang SUN, Beijing (CN); Hong LIU, Beijing (CN); Tianyu ZHOU, Beijing (CN); Binghua ZHANG, Beijing (CN)

(21) Appl. No.: 15/528,163

(22) PCT Filed: Nov. 20, 2015
(86) PCT No.: PCT/CN2015/095209

§ 371 Date: May 19, 2017

(30) Foreign Application Priority Data
Jul. 14, 2015 (CN) 201510412721.8

(51) Int. Cl. G06F 1/32; G06F 1/28; G05B 13/04

(52) U.S. Cl. CPC G06F 1/3296; G05B 13/041; G06F 1/28

(57) ABSTRACT

The present disclosure provides a method and a device for controlling an operation state of a data center. The method includes: calculating operating parameters at an optimal operation state point of the data center in a current outdoor environment condition via an operation state model of the data center according to service requirements of an IT equipment side and tolerable conditions of indoor environment; sending the operating parameters at the optimal operation state point of the data center to the data center, such that the data center operates according to the operating parameters at the optimal operation state point of the data center.

### CROSS-REFERENCE TO RELATED APPLICATION

This application claims priority to and benefits of Chinese Patent Application Serial No. 201510412721.8, titled with “Method and Device for Controlling Operation State of Data Center”, filed with the State Intellectual Property Office of P. R. China on Jul. 14, 2015 by BEIJING BAIDU NETCOM SCIENCE AND TECHNOLOGY CO., LTD., the entire content of which is incorporated herein by reference.

### FIELD

The present disclosure relates to the field of Internet technology, and more particularly, to a method and a device for controlling an operation state of a data center.

### BACKGROUND

With the rising of energy cost and more and more attention on green environmental protection, requirements for energy conservation in a data center have grown stronger and stronger. Under the precondition of ensuring safety and high performance of the Internet Technology (abbreviated as IT) equipment in the computer room of the data center, various energy-saving means are used comprehensively, to increase energy efficiency of the data center and reduce Power Usage Effectiveness (PUE). Energy saving and emission reduction have become one of goals of the data center infrastructure.

When a data center is put into operation, the operation state of the infrastructure is usually adjusted manually according to the indoor and outdoor environment, thereby adjusting the operation state of the computer room, and making the data center operate in an optimal state. When the data centers runs in a stable operation, the operation state of the data center is directly influenced by skills of the operation managers. When the manager does not operate in time or the manager is changed, it may do harm to the continuously stable operation of the data center.

This is due to the different understandings of different operating managers to the optimal operation state and the different operating skills, which make the data center not be able to operate in the most efficient state constantly, and lead to different matching degrees of the actual optimal operation state and a theoretical optimal operation state. Besides, the operating managers may not respond quickly to different situations, and management experience is difficult to be transferred and cannot apply to different computer rooms in short time, which may cause waste of energy and reduction of efficiency to some extent.

### SUMMARY

The present disclosure aims to solve at least one of the technical problems existing in the related art to at least some extent.

Accordingly, a first objective of the present disclosure is to provide a method for controlling an operation state of a data center. With the method, the data center may operate at the optimal operation state point automatically according to the service and environment requirements, and the whole operation state of the data center is the most efficient, with the least energy consumption, and the most stable.

A second objective of the present disclosure is to provide a device for controlling an operation state of a data center.

In order to achieve the above objectives, embodiments according to a first aspect of the present disclosure provide a method for controlling an operation state of a data center, including: calculating operating parameters at an optimal operation state point of the data center in a current outdoor environment condition via an operation state model of the data center according to service requirements of an IT equipment side and tolerable conditions of indoor environment; sending the operating parameters at the optimal operation state point of the data center to the data center, such that the data center operates according to the operating parameters at the optimal operation state point of the data center.

With the method for controlling an operation state of a data center according to embodiments of the present disclosure, the operating parameters at the optimal operation state point of the data center in a current outdoor environment condition are calculated via the operation state model of the data center according to service requirements of the IT equipment side and tolerable conditions of indoor environment, and then the operating parameters at the optimal operation state point of the data center are sent to the data center, so as to make the data center operate according to the operating parameters at the optimal operation state point of the data center, and thus the data center may operate at the optimal operation state point automatically according to service and environment requirements, and the whole operation state of the data center is the most efficient, with the least energy consumption, and the most stable.

In order to achieve the above objectives, embodiments according to a second aspect of the present disclosure provide a device for controlling an operation state of a data center, including: a calculating module, configured to calculate operating parameters at an optimal operation state point of the data center in a current outdoor environment condition via an operation state model of the data center according to service requirements of an IT equipment side and tolerable conditions of indoor environment; a sending module, configured to send the operating parameters at the optimal operation state point of the data center to the data center, such that the data center operates according to the operating parameters at the optimal operation state point of the data center.

With the device for controlling an operation state of a data center according to embodiments of the present disclosure, the calculating module calculates the operating parameters at the optimal operation state point of the data center in a current outdoor environment condition via the operation state model of the data center according to service requirements of the IT equipment side and tolerable conditions of indoor environment, and then the sending module sends the operating parameters at the optimal operation state point of the data center to the data center, so as to make the data center operate according to the operating parameters at the optimal operation state point of the data center, and thus the data center may operate at the optimal operation state point automatically according to the service and environment requirements, and the whole operation state of the data center is the most efficient, with the least energy consumption, and the most stable.

Embodiments of the present disclosure also provide an electronic device, including: one or more processors, a memory and one or more programs stored in the memory that when executed by the one or more processors, perform the following operations: calculating operating parameters at an optimal operation state point of a data center in a current outdoor environment condition via an operation state model of the data center according to service requirements of an IT equipment side and tolerable conditions of indoor environment; sending the operating parameters at the optimal operation state point of the data center to the data center, such that the data center operates according to the operating parameters at the optimal operation state point of the data center.

Embodiments of the present disclosure also provide a non-volatile computer storage medium. One or more modules are stored in the computer storage medium, and when executed, perform the following operations: calculating operating parameters at an optimal operation state point of a data center in a current outdoor environment condition via an operation state model of the data center according to service requirements of the IT equipment side and tolerable conditions of indoor environment; sending the operating parameters at the optimal operation state point of the data center to the data center, such that the data center operates according to the operating parameters at the optimal operation state point of the data center.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

Above and/or other aspects and advantages of the present disclosure will become apparent and more easily to understand from the following descriptions of the embodiments of the present disclosure with reference to the drawings, wherein:

FIG. 1 is a flow chart illustrating a method for controlling an operation state of a data center according to an embodiment of the present disclosure.

FIG. 2 is a flow chart illustrating a method for controlling an operation state of a data center according to another embodiment of the present disclosure.

FIG. 3 is a block diagram illustrating a device for controlling an operation state of a data center according to an embodiment of the present disclosure.

FIG. 4 is a block diagram illustrating a device for controlling an operation state of a data center according to another embodiment of the present disclosure.

### DETAILED DESCRIPTION

Reference will now be made in detail to exemplary embodiments, examples of which are illustrated in the accompanying drawings, wherein the same or similar modules and the modules having same or similar functions are denoted by like reference numerals throughout the descriptions. Embodiments described herein with reference to drawings are explanatory, serve to explain the present disclosure, and are not construed to limit embodiments of the present disclosure. Instead, the embodiments of the present disclosure comprise all the variants, modifications and their equivalents within the spirit and scope of the present disclosure as defined by the claims.

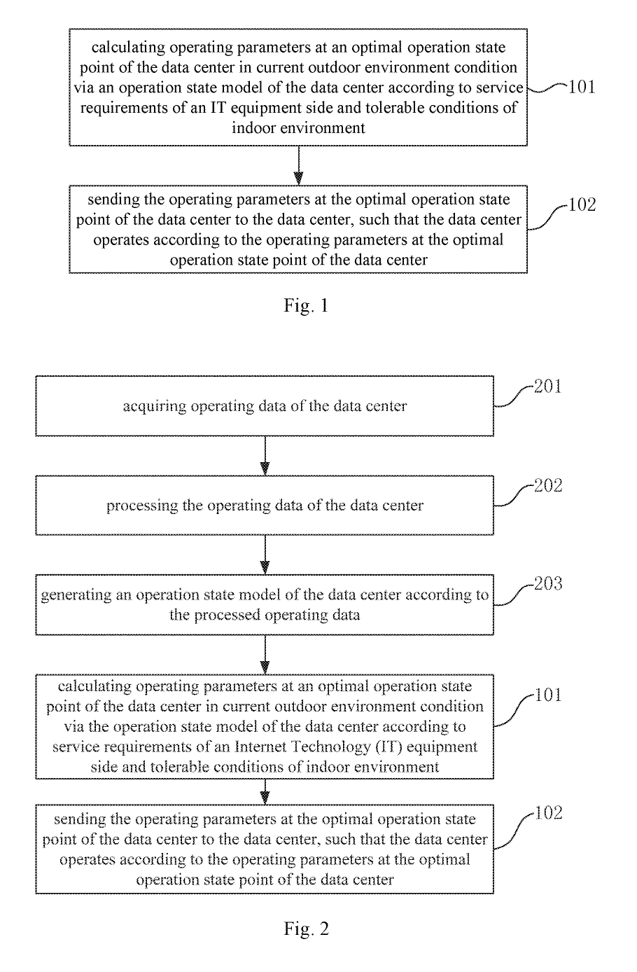

FIG. 1 is a flow chart illustrating a method for controlling an operation state of a data center according to an embodiment of the present disclosure. As shown in FIG. 1, the method for controlling an operation state of a data center may include following actions.

In block 101, operating parameters at an optimal operation state point of the data center in a current outdoor environment condition are calculated via an operation state model of the data center according to service requirements of an IT equipment side and tolerable conditions of the indoor environment.

In detail, the operating parameters at the optimal operation state point of the data center include operating parameters such as an operation state of a water chiller unit, an operation state of a chilled water system, and an operation state of air conditioning terminals.

In block 102, the operating parameters at the optimal operation state point of the data center are sent to the data center, such that the data center operates according to the operating parameters at the optimal operation state point of the data center.

In detail, sending the operating parameters at the optimal operation state point of the data center to the data center may include sending the operating parameters at the optimal operation state point of the data center to an infrastructure side of the data center and an IT equipment side of the data center, so as to make the data center operate at the optimal operation state point constantly. With the above method for controlling an operation state of a data center, the operating parameters at the optimal operation state point of the data center in a current outdoor environment condition are calculated via the operation state model of the data center according to service requirements of the IT equipment side and tolerable conditions of indoor environment, and then the operating parameters at the optimal operation state point of the data center are sent to the data center, such that the data center operates according to the operating parameters at the optimal operation state point of the data center, and thus the data center may operate at the optimal operation state point automatically according to the service and environment requirements, and the whole operation state of the data center is the most efficient, with the least energy consumption, and the most stable.

FIG. 2 is a flow chart illustrating a method for controlling an operation state of a data center according to another embodiment of the present disclosure. As shown in FIG. 2, before block 101, the method may also include the following actions.

In block 201, operating data of the data center is acquired.

In detail, acquiring the operating data of the data center may include: acquiring operating data of the infrastructure side of the data center and the operating data of servers at the IT equipment side of the data center.

More specifically, the operating data acquired from the infrastructure side of the data center may include the outdoor environment parameters, the operation state of the water chiller unit, the operation state of the chilled water system, the operation state of the air conditioning terminal, and inside environment parameters; and the operating data of servers at the IT equipment side of the data center may include load rate of the servers. The above operating data are synchronized in real time.

In block 202, the operating data of the data center is processed.

In detail, processing the operating data of the data center may include: unifying time axis, screening and replacing error points, labeling basic data, and recognizing features for the operating data of the data center, thus achieving fundamental reorganization of the acquired operating data.

In block 203, the operation state model of the data center is generated according to the processed operating data.

In detail, generating the operation state model of the data center according to the processed operating data may include: generating the operation state model of the data center based on the processed operating data by analyzing energy consumption data of the processed operating data, reorganizing data from a statistical perspective, and learning through seeking for rules from big data.

In the method for controlling an operation state of a data center provided in the present disclosure, the data acquiring, data processing, data learning, and data simulating constitute an entire close-loop data link of the operating data of the data center. The above method for controlling an operation state of a data center is based on machine learning and is a continuously optimized, automatic control method of the data center. With the method for controlling an operation state of a data center provided in the present disclosure, a manager of the data center may obtain relationship between the infrastructure and the service and the outdoor environment. A rapid response may be performed according to the obtained relationship, and the management experience is portable and can apply to different computer rooms very fast.

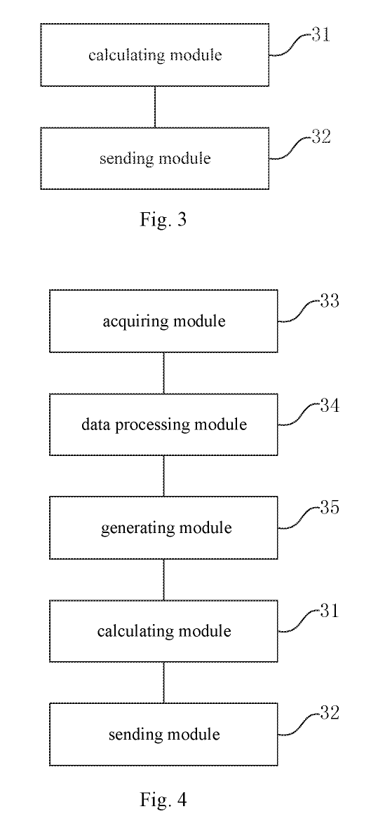

FIG. 3 is a block diagram illustrating a device for controlling an operation state of a data center according to an embodiment of the present disclosure. The device for controlling an operation state of a data center according to the present embodiment may be used to achieve the procedure according to embodiments of the present disclosure shown in FIG. 1. As shown in FIG. 3, the device for controlling an operation state of the data center may include a calculating module 31 and a sending module 32.

The calculating module 31 is configured to calculate operating parameters at an optimal operation state point of the data center in a current outdoor environment condition via an operation state model of the data center according to service requirements of an IT equipment side and tolerable conditions of the indoor environment. In detail, the operating parameters at the optimal operation state point of the data center include operating parameters such as an operation state of a water chiller unit, an operation state of a chilled water system, and an operation state of an air conditioning terminal.

The sending module 32 is configured to send the operating parameters at the optimal operation state point of the data center calculated by the calculating module 31 to the data center, such that the data center operates according to the operating parameters of the optimal operation state point of the data center. In this embodiment, the sending module 32 is configured to send the operating parameters at the optimal operation state point of the data center to an infrastructure side of the data center and the IT equipment side of the data center, so as to make the data center operate at the optimal operation state point constantly.

With the above device for controlling an operation state of a data center, the calculating module 31 calculates the operating parameters at the optimal operation state point of the data center in a current outdoor environment condition via the operation state model of the data center according to service requirements of the IT equipment side and tolerable conditions of indoor environment, and then the sending module 32 sends the operating parameters at the optimal operation state point of the data center to the data center, such that the data center operates according to the operating parameters at the optimal operation state point of the data center, and thus the data center may operate at the optimal operation state point automatically according to the service and environment requirements, and the whole operation state of the data center is the most efficient, with the least energy consumption, and the most stable.

FIG. 4 is a block diagram illustrating a device for controlling an operation state of a data center according to another embodiment of the present disclosure. Compared to the device for controlling an operation state of data center shown in FIG. 3, the difference lies in that, the device for controlling an operation state of data center shown in FIG. 4 may also include an acquiring module 33, a data processing module 34, and a generating module 35.

In detail, the acquiring module 33 is configured to acquire the operating data of the data center. In this embodiment, the acquiring module 33 is specifically configured to acquire the operating data of the infrastructure side of the data center and the operating data of servers at the IT equipment side of the data center. More specifically, the operating data acquired, by the acquiring module 33, from the infrastructure side of the data center may include the outdoor environment parameters, the operation state of the water chiller unit, the operation state of the chilled water system, the operation state of the air conditioning terminal, and inside environment parameters; and the operating data of servers at the IT equipment side of the data center may include load rate of the servers. The above operating data are synchronized in real time.

The data processing module 34 is configured to process the operating data of the data center acquired by the acquiring module 33. In this embodiment, the data processing module 34 is specifically configured to unify time axis, screen and replace error points, label basic data, and recognize features for the operating data of the data center.

The generating module 35 is configured to generate the operation state model of the data center according to the operating data processed by the data processing module 34. In this embodiment, the generating module 35 is specifically configured to generate the operation state model of the data center based on the processed operating data by analyzing energy consumption data of the processed operating data, reorganizing data from a statistical perspective, and learning through seeking for rules from big data.

The above device for controlling an operation state of a data center may automatically adjust and control the operation state of the data center based on machine learning, so as to make the data center operate at the optimal operation state point constantly, and ensure that the whole operation state of the data center is the most efficient, with the least energy consumption, and the most stable.

Embodiments of the present disclosure also provide an electronic device. The electronic device includes: one or more processors, a memory and one or more programs stored in the memory that when executed by the one or more processors, perform the following operations: calculating the operating parameters at the optimal operation state point of the data center in a current outdoor environment condition via the operation state model of the data center according to service requirements of the IT equipment side and tolerable conditions of indoor environment; sending the operating parameters at the optimal operation state point of the data center to the data center, such that the data center operates according to the operating parameters at the optimal operation state point of the data center.

Embodiments of the present disclosure also provide a non-volatile computer storage medium. One or more modules are stored in the computer storage medium, and when executed, perform the following operations: calculating the operating parameters at the optimal operation state point of the data center in a current outdoor environment condition via the operation state model of the data center according to service requirements of the IT equipment side and tolerable conditions of indoor environment; sending the operating parameters at the optimal operation state point of the data center to the data center, such that the data center operates according to the operating parameters at the optimal operation state point of the data center.

It should be noted that in the description of the present disclosure, terms such as “first” and “second” are used herein for purposes of description and are not intended to indicate or imply relative importance or significance or to imply the number of indicated technical features. In addition, in the description of the present disclosure, “a plurality of” means two or more than two, unless specified otherwise.

Any process or method described in a flow chart or described herein in other ways may be understood to include one or more modules, segments or portions of codes of executable instructions for achieving specific logical functions or steps in the process, and the scope of a preferred embodiment of the present disclosure includes other implementations, wherein the order of execution may differ from that which is depicted or discussed, including according to involved function, executing concurrently or with partial concurrence or in the contrary order to perform the function, which should be understood by those skilled in the art.

It should be understood that each part of the present disclosure may be realized by hardware, software, firmware or their combination. In the above embodiments, a plurality of steps or methods may be realized by the software or firmware stored in the memory and executed by the appropriate instruction execution system. For example, if it is realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

Those skilled in the art shall understand that all or parts of the steps in the above exemplifying method of the present disclosure may be achieved by commanding the related hardware with programs, the programs may be stored in a computer-readable storage medium, and the programs comprise one or a combination of the steps in the method embodiments of the present disclosure when running on a computer.

In addition, each function cell of the embodiments of the present disclosure may be integrated into a processing module, or these cells may be separate physical existence, or two or more cells are integrated into a processing module. The integrated module may be realized in a form of hardware or in a form of software function modules. When the integrated module is realized in a form of software function module and is sold or used as a standalone product, the integrated module may be stored in a computer-readable storage medium.

The storage medium mentioned above may be read-only memories, magnetic disks, CD, etc.

Reference throughout this specification to “an embodiment,” “some embodiments,” “an example,” “a specific example,” or “some examples,” means that a particular feature, structure, material, or characteristic described in connection with the embodiment or example is included in at least one embodiment or example of the present disclosure. In this specification, exemplary descriptions of aforesaid terms are not necessarily referring to the same embodiment or example. Furthermore, the particular features, structures, materials, or characteristics may be combined in any suitable manner in one or more embodiments or examples.

Although embodiments of present disclosure have been shown and described above, it should be understood that above embodiments are just explanatory, and cannot be construed to limit the present disclosure, for those skilled in the art, changes, alternatives, and modifications can be made in the embodiments without departing from spirit, principles, and scope of the present disclosure.

1. A method for controlling an operation state of a data center, comprising:
calculating operating parameters at an optimal operation state point of the data center in a current outdoor environment condition via an operation state model of the data center according to service requirements of an Internet Technology equipment side and tolerable conditions of indoor environment;
sending the operating parameters at the optimal operation state point of the data center to the data center, such that the data center operates according to the operating parameters at the optimal operation state point of the data center.

2. The method according to claim 1, wherein, before calculating the operating parameters at the optimal operation state point of the data center in the current outdoor environment condition via the operation state model of the data center according to service requirements of the Internet Technology equipment side and tolerable conditions of indoor environment, the method further comprises:
acquiring operating data of the data center;
processing the operating data of the data center;
generating the operation state model of the data center according to the processed operating data.

3. The method according to claim 2, wherein, acquiring operating data of the data center comprises:
acquiring operating data of an infrastructure side of the data center and operating data of servers at the Internet Technology equipment side of the data center.

4. The method according to claim 2 or 3, wherein, processing the operating data of the data center comprises:
unifying time axis, screening and replacing error points, labeling basic data, and recognizing features for the operating data of the data center.

5. The method according to claim 4, wherein, generating the operation state model of the data center according to the processed operating data comprises:
generating the operation state model of the data center based on the processed operating data by analyzing energy consumption data of the processed operating data, reorganizing data from a statistical perspective, and learning through seeking for rules from big data.

6. The method according to claim 1, wherein, sending the operating parameters at the optimal operation state point of the data center to the data center comprises:
sending the operating parameters at the optimal operation state point of the data center to an infrastructure side of the data center and the Internet Technology equipment side of the data center.

7.-12. (canceled)

13. An electronic device, comprising:
one or more processors;
a memory;
one or program modules, stored in the memory, and configured to perform, a method for controlling an operation state of a data center when executed by the one or more processors,
wherein the one or more program module comprises:
a calculating module, configured to calculate operating parameters at an optimal operation state point of the data center in current outdoor environment condition via an operation state model of the data center according to service requirements of an IT equipment side and tolerable conditions of indoor environment;
a sending module, configured to send the operating parameters at the optimal operation state point of the data center calculated by the calculating module to the data center, such that the data center operates according to the operating parameters at the optimal operation state point of the data center.

14. A non-volatile computer storage medium, stored with instructions that, when executed, by a processor a device, cause the device to perform following actions:
calculating operating parameters at an optimal operation state point of the data center in a current outdoor environment condition via an operation state model of the data center according to service requirements of an Internet Technology equipment side and tolerable conditions of indoor environment;
sending the operating parameters at the optimal operation state point of the data center to the data center, such that the data center operates according to the operating parameters at the optimal operation state point of the data center.

15. The electronic device according to claim 13, wherein the one or more program modules further comprise:
an acquiring module, configured to acquire operating data of the data center;
a data processing module, configured to process the operating data of the data center acquired by the acquiring module;
a generating module, configured to generate the operation state model of the data center according to the operating data processed by the data processing module.

16. The electronic device according to claim 15, wherein,
the acquiring module is configured to acquire operating data of an infrastructure side of the data center and operating data of servers of servers at the Internet Technology equipment side of the data center.

17. The electronic device according to claim 16, wherein,
the acquiring module is configured to acquire operating data of an infrastructure side of the data center and operating data of servers of servers at the Internet Technology equipment side of the data center.

18. The electronic device according to claim 16, wherein,
the data processing module is configured to unify time axis, screen and replace error points, label basic data, and recognize features for the operating data of the data center.

19. The electronic device according to claim 18, wherein,
the generating module is configured to generate the operation state model of the data center based on the processed operating data by analyzing energy consumption data of the processed operating data, reorganizing data from a statistical perspective, and learning through seeking for rules from big data.

20. The electronic device according to claim 13, wherein,
the sending module is configured to send the operating parameters at the optimal operation state point of the data center to an infrastructure side of the data center and the Internet Technology equipment side of the data center.
